(19) United States
(12) Patent Application Publication
(10) Pub. No.: US 2006/0291697 A1
(43) Pub. Date: Dec. 28, 2006

(54) Method and apparatus for detecting the presence of an occupant within a vehicle

(75) Inventor: Yun Luo, Livoinia, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/158,093

(22) Filed: Jun. 21, 2005

(51) Int. Cl. G06K 9/00; G06K 9/62

(52) U.S. Cl. 382/104; 382/224

(57) ABSTRACT

Systems and methods are provided for detecting an occupant within a vehicle. An image of a vehicle interior, containing depth information for a plurality of image pixels, is generated at an image sensor (110). The vehicle interior is divided into at least one blob of contiguous pixels (160). The at least one blob is divided into a series of layers (170) wherein each successive layer represents a range of depth within the image. It is determined if the at least one blob represents an occupant according to at least one characteristic of the series of layers (190).

### TECHNICAL FIELD

The present invention is directed generally to vehicle occupant protection systems and is particularly directed to a method and apparatus for determining the presence of occupants within a vehicle interior.

### BACKGROUND OF THE INVENTION

Occupant position sensors utilized within occupant restraint systems are known in the art. Two examples are shown in U.S. Pat. Nos. 5,531,472 and No. 6,810,133. These systems track the position of a given occupant to maximize the effectiveness of an occupant restraint system. Generally, however, these systems are only included in portions of the vehicle in which one or more occupant restrain systems have been implemented that may benefit from the data provided by the system. Further, the occupant position sensors are generally not active when the car is not active. Accordingly, occupant information is generally not available to the system as the driver is leaving the vehicle, especially information concerning the rear seats of the vehicle. It can be desirable, however, to remind the driver of any occupants remaining in the vehicle before the driver exits the vehicle.

### SUMMARY OF THE INVENTION

In accordance with one aspect of the present invention, a method is provided for detecting an occupant within a vehicle. An image of a vehicle interior, containing depth information for a plurality of image pixels, is generated at an image sensor. The vehicle interior is divided into at least one blob of contiguous pixels. The at least one blob is divided into a series of layers wherein each successive layer represents a range of depth within the image. It is determined if the at least one blob represents an occupant according to at least one characteristic of the series of layers.

In accordance with another aspect of the present invention, a system is provided for determining if an occupant is present in a region of interest. An image generator generates an image of the region of interest, containing depth information for a plurality of image pixels. A blob segmentation component isolates at least one blob of contiguous pixels within the image. A layer segmentation component divides the identified at least one blob into one of a plurality of layers. A given pixel within the at least one blob is assigned to a corresponding layer according to its distance from the image generator. An occupant classifier determines an occupant class for the at least one blob according to at least one characteristic of the layers associated with the blob.

In accordance with yet another aspect of the present invention, a computer program product, implemented in a computer readable medium and operative in a data processing system, is provided for determining if an occupant is present in a region of interest from an image of the region of interest, containing depth information for a plurality of image pixels. A blob segmentation component isolates at least one blob of contiguous pixels within the image. A layer segmentation component divides the identified at least one blob into layers. A given layer is associated with a range of depth within the image. An occupant classifier determines an occupant class for the at least one blob according to at least one characteristic of the layers associated with the at least one blob.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic illustration of a stereo camera arrangement for use with the present invention;

FIG. 2 illustrates an exemplary time of flight system for determining the distance of a target from an associated sensor for use with the present invention;

FIG. 3 illustrates an occupant reminder system for determining the presence of an occupant within a vehicle interior in accordance with an aspect of the present invention;

FIG. 4 illustrates an exemplary methodology for determining the presence of a vehicle occupant in accordance with an aspect of the present invention;

FIG. 5 illustrates a methodology for locating a vehicle seat in accordance with an aspect of the present invention;

FIG. 6 illustrates an exemplary methodology for determining the occupancy of a region of interest from a depth image divided into a plurality of depth layers in accordance with an aspect of the present invention;

FIG. 7 illustrates a second exemplary methodology for determining the occupancy of a region of interest in accordance with an aspect of the present invention; and

FIG. 8 illustrates a computer system that can be employed to implement systems and methods described herein, such as based on computer executable instructions running on the computer system.

### DESCRIPTION OF PREFERRED EMBODIMENT

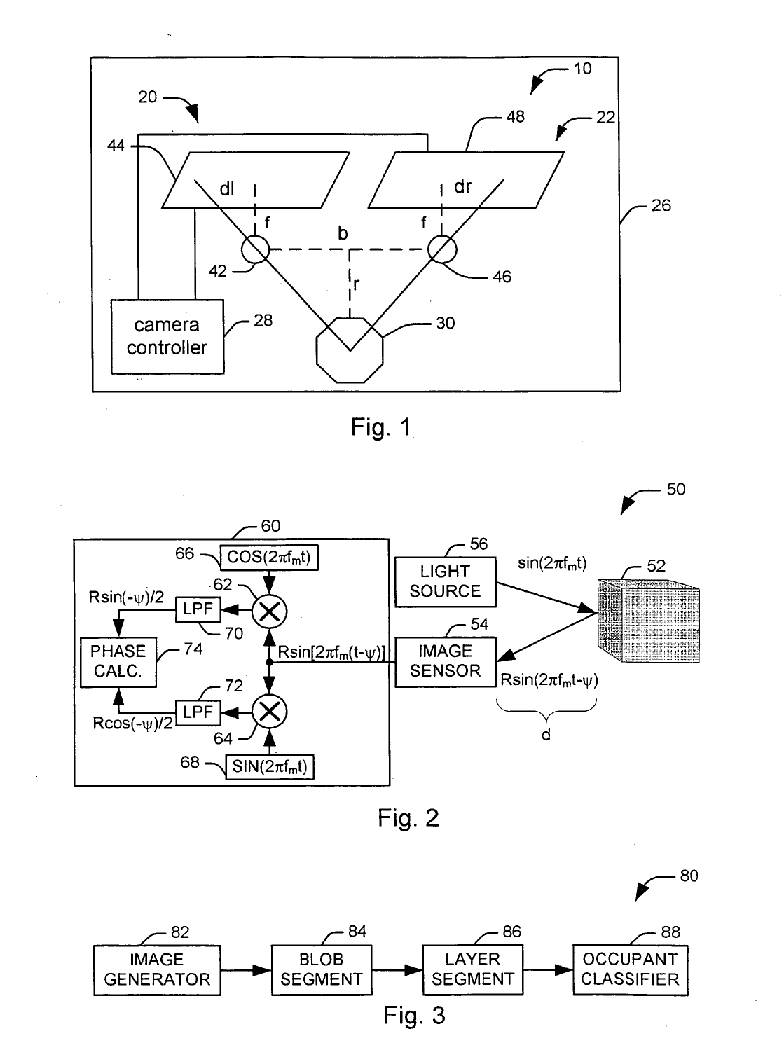

Referring to FIG. 1, an exemplary embodiment of a stereo-vision assembly 10, in accordance with the present invention, is illustrated. The stereo-vision assembly 10 includes stereo-cameras 20 and 22, for example, mounted to a headliner of a vehicle 26. The stereo-vision assembly 10 includes a first camera 20 and a second camera 22, both connected to a camera controller 28. In accordance with one exemplary embodiment of the present invention, the cameras 20, 22 are spaced apart by approximately 35 millimeters (“mm”), although other spacing can be used. The cameras 20, 22 can be positioned in parallel with the front-to-rear axis of the vehicle, although other orientations are possible.

The camera controller 28 can take any of several forms such as a microcomputer, discrete circuitry, ASIC, etc. The camera controller 28 can be connected to a system controller (not shown) and provide a signal to the controller to provide data relating to various image characteristics of the imaged occupant seating area, which can range from an empty seat, an object on the seat, a human occupant, etc. Herein, image data of the seating area is generally referred to as occupant data, which includes all animate and inanimate objects that might occupy the occupant seating area.

The cameras 20 and 22 may be of any several known types. For example, the cameras may be charge-coupled devices (“CCD”) or complementary metal-oxide semiconductor (“CMOS”) devices. Preferably, the cameras 20 and 22 take two-dimensional, grayscale images of one or more rear seats of the vehicle. In one exemplary embodiment of the present invention, the cameras 20 and 22 are wide spectrum response cameras that cover the visible and near-infrared spectrums.

The cameras 20 and 22 are spaced apart from one another so as to enable the cameras to be used for determining a distance, also called a “range,” from the cameras to an object. The object is shown schematically in FIG. 1 and is indicated by reference numeral 30. The distance between the cameras 20 and 22 and the object 30 may be determined by using triangulation. The cameras 20 and 22 have different views of the passenger compartment due to the position of the object 30 relative to each camera 20 and 22 being different. As a result, the object 30 is located at a different position in the image obtained by camera 20 than in the image obtained by camera 22. The difference in the positions of the object 30 in the images is referred to as “disparity.” To get a proper disparity between the images for performing triangulation, it is desirable for the cameras 20 and 22 to be positioned so that the object 30 to be monitored is within the horopter of the cameras.

Camera 20 includes a lens 42 and a pixel array 44. Likewise, camera 22 includes a lens 46 and a pixel array 48. Since the cameras 20 and 22 are located at different positions relative to the object 30, an image of the object 30 formed on the pixel array 44 of camera 20 differs from an image of the object 30 formed on the pixel array 48 of camera 22. The distance between the viewpoints of the cameras 20 and 22 (i.e., the distance between the lenses 42 and 46), is designated “b” in FIG. 1. The focal length of the lenses 42 and 46 of the cameras 20 and 22 is designated as “f” in FIG. 1. The lenses 42 and 46 of the cameras 20 and 22 of FIG. 1 have the same focal lengths. The horizontal distance from the image center on the pixel array 44 and the image of the object 30 on the pixel array 44 of camera 20 is designated “dl” in FIG. 1. The horizontal distance from the image center on the pixel array 48 and the image of the object 30 on the pixel array 48 for the camera 22 is designated “dr” in FIG. 1. Preferably, the cameras 20 and 22 are mounted so that they are in the same image plane. The difference between dl and dr is referred to as the “image disparity” and is directly related to the distance, designated “r” in FIG. 1, to the object 30 where the distance r is measured normal to the image plane of cameras 20 and 22 from a location v on the image plane. It will be appreciated that:
r=bf/d, where d=dl−dr. (Equation 1)

From equation 1, the distance r to the object 30 as a function of disparity of the images from cameras 20 and 22 can be determined. It should be appreciated that the distance r is an inverse function of disparity.

FIG. 2 illustrates an exemplary time of flight system 50 for determining the distance of a target 52 from an associated sensor 54. The illustrated time of flight system 50 can be utilized to determine a depth value for each of a plurality of pixels within a video image. Light, for example, infrared light, is projected onto the target 52 from a modulated active light source 56, such as a laser or an LED. The light is modulated at a modulation frequency, fₘ, such that the emitted light can be modeled as a sine wave, sin(2πfₘt). The reflected light at the sensor has traveled twice a distance, d, to the target, and accordingly acquires a phase shift, ψ, which is a function of the distance traveled. It will be appreciated that the light source 56 and the sensor 54 can be spatially proximate such that the distance between the light source 56 and sensor 54 is negligible when compared to the distance, d, to the target.

The reflected light can be considered to have an amplitude, R, such that the reflected light can be modeled as a phase shifted sine wave, R sin[2πfₘ(t−ψ)]. A signal representing the reflected light can be then provided to a sensor control 60 where it is evaluated at respective mixers 62 and 64. Each mixer 62 and 64 mixes the signal with a sine or cosine reference signal 66 and 68 representing the modulation of the emitted light. The resulting signals contain, respectively, constant or slowly varying values representing the sine and cosine of the additive inverse of the phase difference as well as time dependent components. The time dependent components can be eliminated at low pass filters 70 and 72 to isolate, respective, the sine and the cosine of the additive inverse of the phase difference.

These values can be provided to a phase calculator 74 that calculates the phase of the signal from the provided components. In an exemplary implementation, the phase calculator 74 divides the sine value by the cosine value, takes the additive inverse of the quotient, and determines the arctangent of the result to find an appropriate phase difference value. The distance, d, can be determined from the phase difference, ψ, according to the following equation:

$$d = \frac{c ψ}{4 π {f}_{m}} \qquad ( Equation 2 )$$

Referring to FIG. 3, an occupant reminder system 80 is provided for determining the presence of an occupant within a vehicle interior. It will be appreciated that one or more portions of the system 80 can be implemented as computer software on a general purpose processor. The system 80 includes an image generator 82 that creates an image of the vehicle compartment, containing depth information for a plurality of image pixels. For example, the image generator 82 can include two or more sensors, embedded in the headliner of the vehicle, that are configured to obtain respective images of the rear seating area of the vehicle. The image generator 82 produces a stereo disparity map from the outputs of the two or more sensors. Alternatively, the image generator 82 can obtain depth information via a time of flight calculation for each pixel. During image generation, the image or images from the sensor can be preprocessed to increase the associated dynamic range of the images and to remove static background elements.

The output of the image generator 82 is provided to a blob segmentation component 84. The blob segmentation component 84 identifies and isolates individual areas of occupied space within the image to break the occupied space into individual blobs. Each blob represents a candidate occupant within the region of interest. For example, the blob segmentation component 84 can identify blobs of adjacent pixels within the region of interest that exceed a threshold size. It will be appreciated that more sophisticated segmentation algorithms can be used in accordance with an aspect of the present invention.

The segmented blobs are provided to a layer segmentation component 86. The layer segmentation component 86 effectively divides the blobs of the vehicle compartment into a number of horizontal layers. For example, five layers can be defined in relation to the vehicle seat, such that the identification of an object within one or more layers is indicative of its vertical position relative to the seat. The layer segmentation component 86 can represent each layer as a two-dimensional map of the occupied space within the layer.

The layer information for each blob is then provided to an occupant classification system 88. The occupant classification system 88 determines if the blob represents an occupant from the layer information. The occupant classification system 88 can contain appropriate components or software for identifying blobs representing occupants and, optionally, determining an associated occupant class for the blob (e.g., adult, child, unoccupied rearward facing infant seat, occupied rearward facing infant seat, unoccupied frontward facing infant seat, and occupied frontward facing infant seat).

The occupant classification system 88 can generate statistics for one or more of the layers as classification features based on the layer information associated with the blob. For example, the percentage of the total blob area associated with each layer of the image can be calculated. Other features can include the first and second order moments of the pixels comprising each layer of the blob, and depth values in a downsized occupant range image that represents the blob as a small number of pixels having averaged depth values for a larger region of the blob that they represent. These features can then be provided to a classification system. In one implementation, the classification system comprises a rule based classifier that determines an occupant class according to a set of logical rules. For example, the calculated percentages of occupied pixels for each layer of the blob can be compared to threshold values in one or more layers to determine a class for the candidate occupant represented by the blob.

Alternatively, the classification system 88 can comprise a Support Vector Machine (“SVM”) algorithm or an artificial neural network (“ANN”) learning algorithm to determine an occupant class for the candidate occupant. A SVM classifier can utilize a plurality of functions, referred to as hyperplanes, to conceptually divide boundaries in an N-dimensional feature space, where each of the N dimensions represents one feature (e.g., layer characteristic) provided to the SVM classifier. The boundaries define a range of feature values associated with each class. Accordingly, an output class can be determined for a given input according to its position in feature space relative to the boundaries.

An ANN classifier comprises a plurality of nodes having a plurality of interconnections. The layer characteristic values are provided to a plurality of input nodes. The input nodes each provide these input values to layers of one or more intermediate nodes. A given intermediate node receives one or more values from previous nodes. The received values are weighted according to a series of weights established during the training of the classifier. An intermediate node translates its received values into a single output according to a transfer function at the node. For example, the intermediate node can sum the received values and subject the sum to a binary step function. These outputs can in turn be provided to additional intermediate layers, until an output layer is reached. The output layer comprises a plurality of outputs, representing the output classes of the system. The output class having the best value (e.g., largest, smallest, or closest to a target value) is selected as the output class for the system.

In an alternative embodiment, the classification system 88 can identify candidate objects within each layer of the blobs. For example, the candidate objects can include shapes within the blob that may represent portions of the human body and objects indicative of an occupants' presence, such as infant seats. The present invention can utilize any of a number of algorithms for identifying and segmenting candidate objects within an image. Once the candidate objects are identified, they are matched to object templates associated with the system. The object templates can represent objects of interest associated with a vehicle occupant. It will be appreciated that the object templates used for a given layer can vary to account for the prevalence of the object type at that depth and the appearance of the object to the image sensor at a given depth. Accordingly, each individual layer can have its own set of associated templates for objects expected to appear with the layer.

For example, an upper layer of the system can contain templates used for locating an occupant's head (e.g., an adult's head or the head of a standing child). Since the upper layer of the vehicle can be clearly imaged from the image sensor, a simple round or elliptical shape can be utilized as a head template. Candidate objects matching the templates can be considered as head candidates. Other processing steps and historical data on the object can be used to ensure that the object represents a human head, and to determine if it is the head of a seated adult or a child standing within the vehicle.

Other templates can be applied to lower layers within the vehicle. For example, templates for the torso, legs, and head of an adult or child over several positions (e.g., standing, seated, lying on the seat) can be utilized at several lower layers, with the template designed to reflect the likely appearance of the shape at the image sensor given the associated depth of the layer. Similarly, templates for child and infant seats can be included at the lower level. These templates can include seats of varying shape and concavity to determine if the seat is occupied and if the seat is frontward facing or rearward facing.

In another alternative implementation, images can be taken over a period of time to detect motion within each of the image layers. It will be appreciated that motion within the region of interest is generally indicative of the presence of an occupant, but the motion can be quantified and evaluated at a classifier to eliminate false alarms. In simplest form, the classifier can comprise a rule based classifier that determines if the motion exceeds a threshold displacement value over a predetermined period of time. More sophisticated classification algorithms can be applied to eliminate alarms due to air circulation and other external factors within the vehicle. Even where motion within the vehicle is not directly utilized for occupant detection and classification, historical information, representing past image frames, can be utilized in classifying and confirming the class of a given candidate occupant.

It will be appreciated that the techniques described above in relation to the occupant classification system 88 are neither mutually exclusive nor exhaustive. Multiple techniques from those described above can be utilized in concert to reliably classify the occupancy of the region of interest. Other techniques not described for utilizing the layer information to determine the occupancy of the vehicle will be appreciated by one skilled in the art in light of the teachings of the present invention.

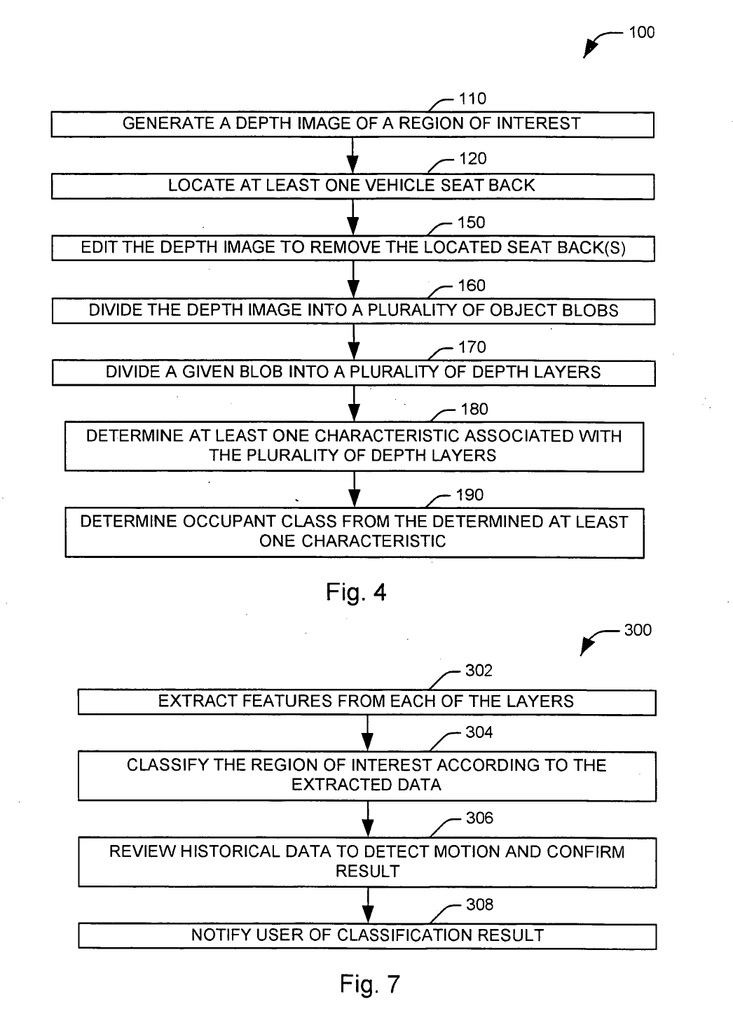

In view of the foregoing structural and functional features described above, methodologies in accordance with various aspects of the present invention will be better appreciated with reference to FIGS. 4-7. While, for purposes of simplicity of explanation, the methodologies of FIGS. 4-7 are shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 4 illustrates an exemplary methodology 100 for determining the presence of a vehicle occupant in accordance with an aspect of the present invention. The methodology 100 begins at step 110 where a depth image is generated of a vehicle seat. It will be appreciated that multiple cameras can be utilized to generate images of a common subject from multiple perspectives, as to facilitate the generation of a stereo disparity map from the generated images. Alternatively, a time of flight system can be utilized to obtain depth information for the image. At step 120, one or more seat backs are located within the image, and respective regions of interest are defined around the seat back. Once the seat back has been located in the image, the image can be edited at step 150 to remove the seat back and the head rest. At step 160, the image is divided into a plurality of object blobs, representing candidate occupants with the image. This can be accomplished by isolating groups of contiguous pixels within the image.

The methodology then advances to step 170, where the blobs are divided into a plurality of depth layers. It will be appreciated that a given image has a two-dimensional plane in which depth information representing a third dimension is represented for each pixel on the plane. The plurality of layers can be defined to be parallel to the two-dimensional plane of the image sensor, with each layer containing pixels representing an associated range of depth. For example, each successive layer can represent an increased distance from the image sensor relative to preceding layers in the series.

At step 180, at least one characteristic associated with the depth layers for each blob is determined. For example, a percentage of occupied pixels at the layer can be determined for each layer. In essence, for a given depth layer, this percentage can indicate the percentage of pixels at a given depth layer or below. Other characteristics used in classifying the image can include the first and second moments of each layer of the blob, a degree of motion detected overall and in each layer, and average depth values for particular regions of the blob. For example, a given blob can be downsized into a smaller image having pixels representing regions of the blob. The depth value for each pixel, representing an average depth value for its associated region, can be utilized as a feature for classification.

At step 190, the determined features are used to determine an occupant class for the candidate occupant represented by a given blob. In accordance with the present invention, the blobs can be classified into one of a plurality of possible classes such as an adult class, a child class, an occupied rearward facing infant seat class, an unoccupied rearward facing infant seat class, an occupied forward facing infant seat class, an unoccupied forward facing infant seat class, and an nonoccupant class. These classes are given only for the purpose of example, and less or more classes can be used as well as classes different from those listed. The classification process can utilize any of a number of intelligent systems suitable for classifying an input image.

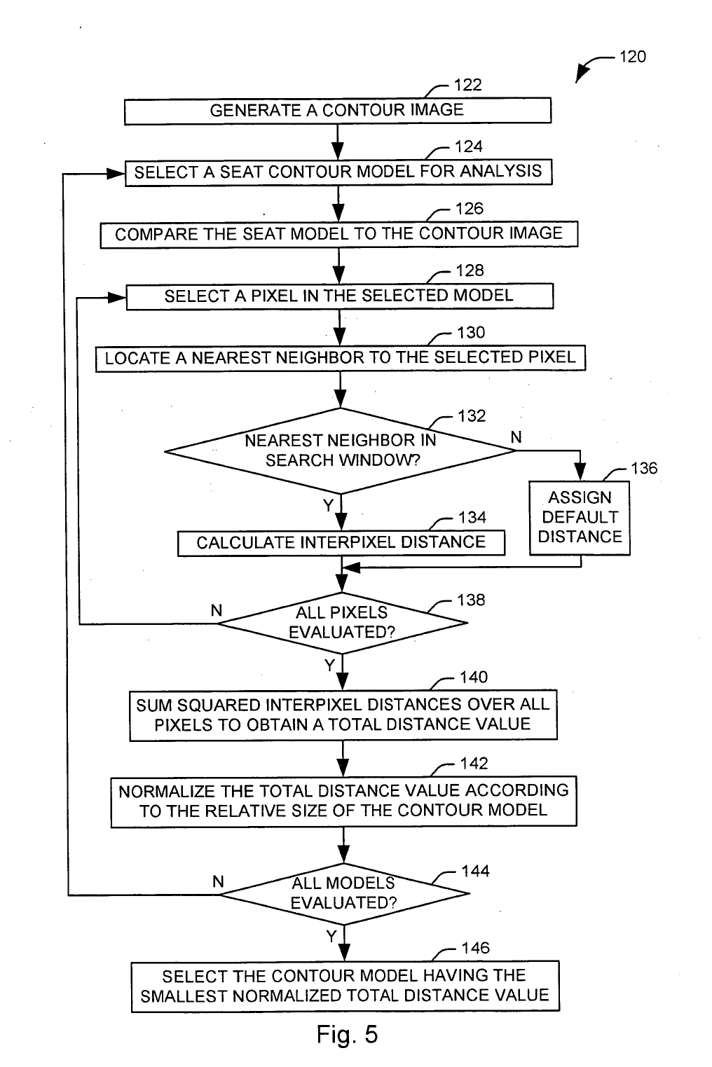

FIG. 5 illustrates a methodology 120 for locating a vehicle seat in accordance with an aspect of the present invention. The process begins at step 122 where a contour image is generated from the image. This can be done by any appropriate means for detecting abrupt changes in intensity throughout an image, such as a Canny edge detector. It will be appreciated that the contour image can contain depth information such that the contour image provides a three-dimensional representation of one or more contours depicted by the images. At step 124, a three-dimensional seat contour model is selected from a plurality of available seat contour models for analysis. Each of the contour models represents the contour of the seat from an overhead view when the seat is in a given position, according to one or more ranges of motion associated with the seat. It will be appreciated that the contour models comprise both two-dimensional position data within the plane of the image as well as depth information associated with the given seat position. The contour models can be selected in a predetermined order or can be selected according to feedback from an occupant protection system.

At step 126, the selected contour model is compared to a contour image depicting a vehicle seat. For example, the position of the pixels in the contour model can be assigned corresponding locations within a coordinate system defined by the contour image to allow for the comparison of the pixel positions across the contour model and the contour image. It will be appreciated that the contour models can be generated utilizing the same perspective as the contour images provided for analysis for a given vehicle, such that the correspondence between pixel locations on the contour model and the contour image is straightforward.

The contour model can comprise a number of reference points, corresponding to selected representative pixels within the contour model. At step 128, a reference point in the selected model is selected. The pixels can be selected in a predetermined order associated with the contour model. At step 130, a “nearest neighbor” to the selected reference point is determined from the reference points comprising the contour image. This can be accomplished by any of a number of nearest neighbor search algorithms that are known in the art. At step 132, it is determined if the determined nearest neighbor is within a defined search window. The search window can be defined to prevent a neighboring pixel from exceeding a threshold distance from the selected reference point in any of the coordinate dimensions. As will be appreciated, the coordinate dimensions can include the width and height dimensions in a two-dimensional image, as well as a third dimension representing the depth information in the image.

If the neighboring pixel is within the defined search window (Y), the distance between the selected reference point and the neighboring pixel is calculated at step 134. It will be appreciated that any of a number of distance measures can be utilized, including Euclidean and Manhattan distances. The methodology then advances to step 138. If the neighboring pixel is not in the defined search window (N), a default distance greater than the maximum range of the search window is assigned at step 136, and the methodology then advances to step 138.

At step 138, it is determined if all of the reference points within the contour model have been evaluated. If not (N), the methodology returns to step 128, where another reference point is selected. Once all reference points have been selected (Y), the methodology advances to step 140, where the squares of the determined distance values for the plurality of reference points within the contour are summed to form a total distance value. The total value is then normalized according to the size (e.g., area, volume, or number of representative reference points) of the contour model at step 142. Appropriate normalization values for each contour model can be determined when the contour models are generated. In one implementation, the normalization includes dividing the sum of the squared distances by the number of reference points in the contour model.

At step 144, it is determined if all the plurality of contour models have been evaluated. If not (N), the methodology returns to step 124, where another model is selected. Once all models have been evaluated (Y), the methodology advances to step 146, where the model having the smallest normalized total distance value is selected. The methodology 120 then terminates.

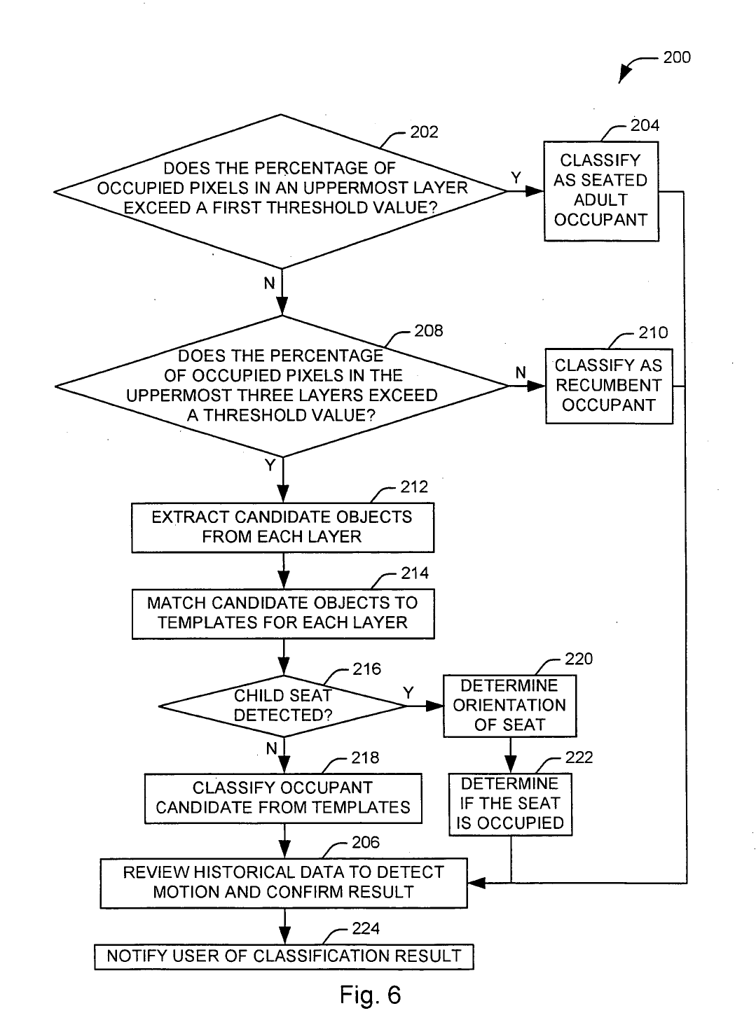

FIG. 6 illustrates an exemplary methodology 200 for determining the occupancy of a region of interest from a depth image divided into a plurality of depth layers in accordance with an aspect of the present invention. For the purpose of the illustrated methodology 200, the layers can be defined as a first layer, comprising a region above the back of the vehicle seat, a second layer, comprising a region just below the empty seat back, a third layer, comprising a region toward the middle of the seat back, a fourth layer, comprising a region just above the seat bottom, and a fifth layer which includes a region below the seat bottom. The pixels in the fifth layer are generally discarded as they give little information about the presence or absence of an occupant. The methodology 200 utilizes a rule based classifier in combination with a template matching system to determine an occupant class of a candidate occupant, represented as a blob in the depth image, according to one or more characteristics.

The methodology 200 begins at step 202, where it is determined if a percentage of total blob pixels that are associated with the first layer of the blob exceeds a first threshold value. A significant percentage of pixels in the first layer generally indicates that an occupant's head extends into the region above the seat back, which, in turn, indicates the presence of a seated adult. Accordingly, if the percentage exceeds the threshold (Y), the methodology advances to step 204, in which the occupant is classified as a sitting adult. The methodology then advances to step 206.

If the percentage does not exceed the threshold (N) in step 202, the methodology proceeds to step 208, where the percentage of total blob pixels that are associated with the first, second, and third layers is compared to a second threshold. A small number of pixels in the first, second, and third layers of the blob, coupled with a large pixel blob in the fourth layer, generally indicates a recumbent occupant, as only a small portion of a recumbent occupant is likely to extend into the mid-region of the seat back. Accordingly, if the percentage does not exceed the threshold (N), the methodology advances to step 210, in which the occupant is classified as a recumbent occupant. The methodology then advances to step 206

If the percentage does exceed the threshold (Y) in step 208, the methodology proceeds to step 212, where candidate objects are extracted from each layer of the blob. The candidate objects can include shapes within the blob that may represent portions of the human body and objects indicative of an occupant's presence, such as infant seats. The present invention can utilize any of a number of algorithms for identifying and segmenting candidate objects within an image. The methodology then advances to step 214, where the candidate objects are matched to object templates associated with the various depth layers. For example, the first and second layers of the system can contain round or elliptical templates used for locating an occupant's head. Templates for car seats and portions of car seats may be associated with the third or fourth depth layer of the blobs. One skilled in the art will appreciate that other templates may be useful in determining an associated object class of the occupant in light of the teachings of the present invention.

At step 216, it is determined if a candidate object associated with a car seat or a portion of a car seat has been detected. If not (N), the methodology advances to step 218, where the occupant is classified according to the matching candidate object templates. Each template can have one or more associated occupant classes, and provide confidence for its associated classes. This confidence can be aggregated by an appropriate combinational rule until a threshold level of confidence associated with a given occupant class is achieved. For example, a matching head template in the fourth region and two small leg templates matched in the fourth region may provide enough confidence to indicate that the blob represents a child or small adult. Other such combinations will be apparent to one skilled in the art in light of the teachings of the present invention. The methodology then continues to step 206.

If the blob does contain templates associated with a infant seat (Y) in step 216, the methodology proceeds to step 220, where the orientation of the infant seat is determined (e.g., rearward facing infant seat or frontward facing infant seat). This can be accomplished, for example, comparing the average depth of the frontward and rearward ends of the seat. Frontward facing seats generally have a rearward end having a height that is greater than the height of the frontward end. Once the type of seat has been determined, the seat bottom and interior region of the infant seat can be determined with relative ease according to their position relative to the front and rear ends of the seat. At step 222, it is determined if the seat is occupied. With the orientation of the seat being known, it is possible to scan over the entire region of the seat from a first end to a second end to determine how the depth of the seat changes within the interior region. If the interior region is concave, the infant seat is unoccupied. If the interior region is convex, the infant seat is considered to be occupied. The methodology then advances to step 206.

At step 206, historical data on the image can be consulted to detect occupant motion and to confirm the result. For example, consistent motion detected over time can be considered confirmation that an occupant is present. In addition, the result itself can be checked against previous results for consistency. For example, it is relatively easy to confuse a seated adult and a standing child during classification, but the two classes can be distinguished by tracking the height of the occupant's head over a period of time. The result is communicated to the driver at step 224. For example, a visual or aural alarm can be actuated in response to a detected occupant in the rear seat or seats of the vehicle. In an exemplary implementation, the nature of the alarm can be varied according to the associated occupant class of the occupant.

FIG. 7 illustrates a second exemplary methodology 300 for determining the occupancy of a region of interest in accordance with an aspect of the present invention. The methodology 300 utilizes a pattern recognition classifier to determine an occupant class of a candidate occupant represented as a blob in a depth image according to one or more characteristics. The blob can be divided into a plurality of layers representing depths within an area of interest. The methodology begins at step 302, in which features can be extracted from each of the plurality of layers. For example, the percentage of each layer that is occupied in the image can be calculated as a feature as well as the first and second order moments of each layer. In one implementation, the image can be condensed into a downsized image that represents the region of interest as a small number of pixels having averaged depth values for the image region they represent. The depth values for one or more of these pixels can be utilized as features.

At step 304, the extracted features are used to classify the candidate occupant represented by the blob at a pattern recognition classifier. In a simplest case, the classifier can be trained on a plurality of blob images detecting both situations in which the blob represents an occupant and situations in which the blob does not represent an occupant. A more complex classification can be achieved by generating blob images of various classes of occupants (e.g., sitting adult, recumbent adult, standing child, sitting child, recumbent child, occupied rearward facing infant seat, unoccupied rearward facing infant seat, occupied frontward facing infant seat, and unoccupied frontward facing infant seat) and training the classifier on these images. The classifier can comprise any suitable classifier for distinguishing between the plurality of occupant classes. For example, the classification can be performed by an artificial neural network or a support vector machine.

At step 306, historical data on the image can be consulted to detect occupant motion and to confirm the result. For example, if the classification has a low confidence, the presence of an occupant can be assumed if there is a significant amount of motion (e.g., change between temporally proximate images) in the recorded image. In addition, the result itself can be checked against previous results for consistency. For example, it is difficult to distinguish a seated adult from a standing child during classification. However, such discrimination can be made by tracking the height of the occupant's head over a period of time. The result is communicated to the driver at step 308. For example, a visual or aural alarm can be actuated in response to a detected occupant in the rear seat or seats of the vehicle. In an exemplary implementation, the alarm can be varied according to the associated occupant class of the occupant.

It will be appreciated that the operation of the alarm can depend on additional vehicle sensor input. Specifically, it may be desirable to operate the alarm only when it is determined that the driver may be about to leave the vehicle, such that the driver is alerted to the presence of occupants in the rear of the vehicle before he or she leaves the vehicle. For example, a vehicle's driver door open sensor can be used to determine if it is appropriate to operate the alarm. Other sensors can also be utilized, such as weight sensors in the driver's seat or a machine vision sensor for locating and identifying the driver.

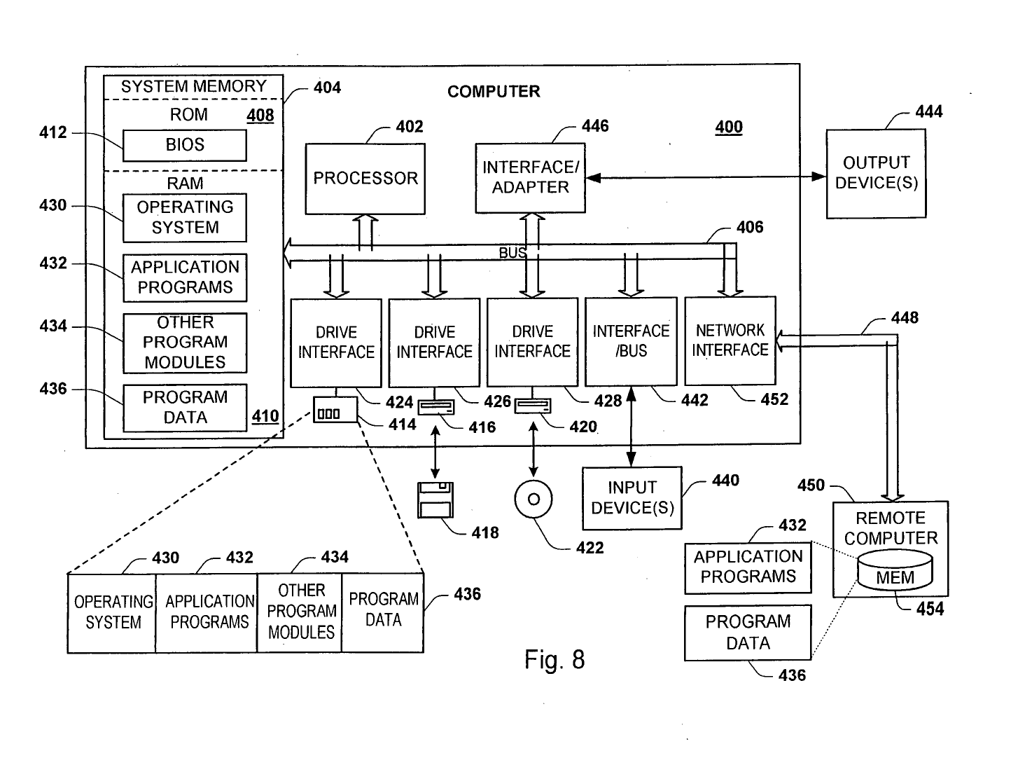

FIG. 8 illustrates a computer system 400 that can be employed to implement systems and methods described herein, such as based on computer executable instructions running on the computer system. The computer system 400 can be implemented on one or more general purpose networked computer systems, embedded computer systems, routers, switches, server devices, client devices, various intermediate devices/nodes and/or stand alone computer systems. Additionally, the computer system 400 can be implemented as part of the computer-aided engineering (CAE) tool running computer executable instructions to perform a method as described herein.

The computer system 400 includes a processor 402 and a system memory 404. A system bus 406 couples various system components, including the system memory 404 to the processor 402. Dual microprocessors and other multi-processor architectures can also be utilized as the processor 402. The system bus 406 can be implemented as any of several types of bus structures, including a memory bus or memory controller, a peripheral bus, and a local bus using any of a variety of bus architectures. The system memory 404 includes read only memory (ROM) 408 and random access memory (RAM) 410. A basic input/output system (BIOS) 412 can reside in the ROM 408, generally containing the basic routines that help to transfer information between elements within the computer system 400, such as a reset or power-up.

The computer system 400 can include a hard disk drive 414, a magnetic disk drive 416 (e.g., to read from or write to a removable disk 418) and an optical disk drive 420 (e.g., for reading a CD-ROM or DVD disk 422 or to read from or write to other optical media). The hard disk drive 414, magnetic disk drive 416, and optical disk drive 420 are connected to the system bus 406 by a hard disk drive interface 424, a magnetic disk drive interface 426, and an optical drive interface 434, respectively. The drives and their associated computer-readable media provide nonvolatile storage of data, data structures, and computer-executable instructions for the computer system 400. Although the description of computer-readable media above refers to a hard disk, a removable magnetic disk and a CD, other types of media which are readable by a computer, may also be used. For example, computer executable instructions for implementing systems and methods described herein may also be stored in magnetic cassettes, flash memory cards, digital video disks and the like.

A number of program modules may also be stored in one or more of the drives as well as in the RAM 410, including an operating system 430, one or more application programs 432, other program modules 434, and program data 436.

A user may enter commands and information into the computer system 400 through user input device 440, such as a keyboard, a pointing device (e.g., a mouse). Other input devices may include a microphone, a joystick, a game pad, a scanner, a touch screen, or the like. These and other input devices are often connected to the processor 402 through a corresponding interface or bus 442 that is coupled to the system bus 406. Such input devices can alternatively be connected to the system bus 406 by other interfaces, such as a parallel port, a serial port or a universal serial bus (USB). One or more output device(s) 444, such as a visual display device or printer, can also be connected to the system bus 406 via an interface or adapter 446.

The computer system 400 may operate in a networked environment using logical connections 448 to one or more remote computers 450. The remote computer 448 may be a workstation, a computer system, a router, a peer device or other common network node, and typically includes many or all of the elements described relative to the computer system 400. The logical connections 448 can include a local area network (LAN) and a wide area network (WAN).

When used in a LAN networking environment, the computer system 400 can be connected to a local network through a network interface 452. When used in a WAN networking environment, the computer system 400 can include a modem (not shown), or can be connected to a communications server via a LAN. In a networked environment, application programs 432 and program data 436 depicted relative to the computer system 400, or portions thereof, may be stored in memory 454 of the remote computer 450.

From the above description of the invention, those skilled in the art will perceive improvements, changes, and modifications. Such improvements, changes, and modifications within the skill of the art are intended to be covered by the appended claims.

Having described the invention, the following is claimed:

1. A method for detecting an occupant within a vehicle comprising:
generating an image of a vehicle interior, containing depth information for a plurality of image pixels, at an image sensor;
dividing the image of the vehicle interior into at least one blob of contiguous pixels;
dividing the at least one blob into a series of layers, wherein each layer in the series of layers represents a range of depth within the image; and
determining if the at least one blob represents an occupant according to at least one characteristic of the series of layers.

2. A method as set forth in claim 1, wherein the step of determining if the at least one blob represents an occupant according to at least one characteristic of the series of layers comprises the steps of:
generating statistics for each layer according to at least one associated characteristic; and
determining if the at least one blob represents an occupant according the generated statistics.

3. A method as set forth in claim 2, wherein the step of generating statistics for each layer includes the step of calculating the percentage of total pixels within the at least one blob that have a depth value associated with the layer.

4. A method as set forth in claim 3, wherein the step of determining if the at least one blob represents an occupant includes the step of comparing the calculated percentage for a given layer to a threshold value associated with the layer.

5. A method as set forth in claim 2, wherein the step of determining if the at least one blob represents an occupant comprises the steps of:
providing the generated statistics for each layer to a pattern recognition classifier; and
determining an occupant class for the at least one blob at the pattern recognition classifier.

6. A method as set forth in claim 1, wherein the step of determining if the at least one blob represents an occupant according to at least one characteristic of the series of layers comprises the steps of:
identifying candidate objects within each of the series of layers; and
matching the candidate objects to at least one set of templates, a given template in the at least one set of templates being associated with one of a car seat and a portion of a human body.

7. A method as set forth in claim 6, wherein each of the series of layers has an associated set of templates from the at least one set of templates and the step of matching the candidate objects comprises the step of matching the identified candidate objects within a given layer to the set of templates associated with the layer.

8. A method as set forth in claim 1, wherein the step of determining if the at least one blob represents an occupant according to at least one characteristic of the layers comprises the steps of:
detecting motion within at least one layer of the series of layers over a period of time; and
determining if the at least one blob represents an occupant according the detected motion.

9. A method as set forth in claim 1, further comprising the step removing a vehicle seat from the image.

10. A method as set forth in claim 1, further comprising the step of alerting a driver of the vehicle, via an alarm, if the at least one blob represents an occupant.

11. The method of claim 10, further comprising the steps of:
classifying the at least one blob to determine an associated occupant class; and
varying the alarm according to the associated occupant class of the at least one blob.

12. The method of claim 1, wherein the step of determining if the at least one blob represents an occupant comprises the steps of:
classifying the at least one blob-to determine an associated occupant class; and
comparing the determined occupant class of the at least one blob to at least one occupant class determined for the at least one blob in a previous image of the vehicle interior.

13. The method of claim 1, wherein the image sensor is located in a headliner of the vehicle interior.

14. A system for determining if an occupant is present in a region of interest within a vehicle interior comprising:
an image generator that generates an image of the region of interest, containing depth information for a plurality of image pixels;
a blob segmentation component that isolates at least one blob of contiguous pixels within the image;
a layer segmentation component that divides the identified at least one blob into a plurality of layers, wherein a given pixel within the at least one blob is assigned to a corresponding layer according to its distance from the image generator; and
an occupant classifier that determines an occupant class for at least one blob according to at least one characteristic of the layers associated with the at least one blob.

15. The system of claim 14, the occupant classifier being operative to identify candidate objects associated with each layer of the at least one blob and match a given identified candidate object to a set of templates for the associated layer of the candidate object.

16. The system of claim 14, the occupant classifier comprising a pattern recognition classifier that classifies the at least one blob according to a plurality of features associated with the layers comprising the at least one blob.

17. The system of claim 16, the occupant classifier being operative to condense an image of the at least one blob into a downsized image comprising a plurality of pixels in which each pixel of the downsized image has a depth value representing an average depth value for a defined region of pixels within the at least one blob, the plurality of features comprising the depth values of the pixels comprising the downsized image.

18. The system of claim 14, each of the plurality of layers being parallel to a bottom of a seat within the vehicle interior.

19. The system of claim 14, the image generator being operative to generate depth information for the image via a time of flight system.

20. The system of claim 14, the image generator comprising a stereovision system operative to generate a stereo disparity map of the vehicle interior.

21. A computer program product, implemented in a computer readable medium and operative in a data processing system, for determining if an occupant is present in a region of interest from an image of the region of interest, containing depth information for a plurality of image pixels, comprising:
a blob segmentation component that isolates at least one blob of contiguous pixels within the image;
a layer segmentation component that divides the at least one blob into a plurality of layers, a given layer being associated with a range of depth within the image; and
an occupant classifier that determines an occupant class for the at least one blob according to at least one characteristic of the layers associated with the at least one blob.

22. The computer program product of claim 21, the occupant classifier comprising a rule based classifier, and the at least one characteristic comprising a percentage of the total pixels comprising the at least one blob that are associated with a given layer of the at least one blob.

23. The computer program product of claim 21, the occupant classifier comprising at least one of an artificial neural network and a support vector machine, and the at least one characteristic comprising first and second moments of the pixels comprising a given layer of the at least one blob.

24. The computer program product of claim 21, the at least one characteristic comprising detected motion within each layer of the at least one blob.
